(19) United States
(12) Patent Application Publication
(10) Pub. No.: US 2013/0301083 A1
(43) Pub. Date: Nov. 14, 2013

(54) IMAGE INSPECTION DEVICE, IMAGE INSPECTION SYSTEM, IMAGE INSPECTION METHOD, AND COMPUTER PROGRAM

(71) Applicant: CANON KABUSHIKI KAISHA, Tokyo (JP)

(72) Inventor: Kanako Kaneda, Kamakura-shi (JP)

(73) Assignee: CANON KABUSHIKI KAISHA, Tokyo (JP)

(21) Appl. No.: 13/873,757

(22) Filed: Apr. 30, 2013

(30) Foreign Application Priority Data
May 11, 2012 (JP) 2012-109443

(51) Int. Cl. H04N 1/00

(52) U.S. Cl. CPC H04N 1/00005
USPC 358/406

(57) ABSTRACT

A device comprises: a scanning unit configured to scan a printed material obtained by printing image data; a setting unit configured to set reference data based on the image data; and a determining unit configured to determine whether a printed material is proper by comparing the image data obtained by the scan with the reference data, wherein the setting unit sets again the reference data based on the image data obtained by the scan for a subsequent printed material in a case where the determining unit determines a printed material to be proper.

### BACKGROUND OF THE INVENTION

1. Field of the Invention

The present invention relates to an image inspection device, an image inspection system, an image inspection method, and a computer program, for determining the quality of an image, and in particular relates to the image inspection system, image inspection method, and computer program, for determining the quality of an image formed on a recording medium.

2. Description of the Related Art

There has been proposed a system in which the quality of an image formed on a sheet-shaped recording medium is determined by an image forming device (see Japanese Patent Laid-Open No. 2011-146033).

Japanese Patent Laid-Open No. 2011-146033 discloses a method of determining the quality of an image formed on a recording medium by comparing image data obtained by subjecting original image data to an intermediate treatment in a process of forming an image, with scanned image data obtained by scanning the image formed on the recording medium. In this comparison processing, image data prior to the intermediate treatment is restored by using image data obtained by smoothing halftone dots included in the image data subjected to the intermediate treatment. Then, by setting of this restored image data to a reference and by a comparison between this reference and the scanned image data, a determination (an inspection) is performed whether the quality of the image on a recording medium is good or bad while the influence of the halftone dots after the intermediate treatment is suppressed. That is, in the inspection disclosed in Japanese Patent Laid-Open No. 2011-146033, the image data derived from original image data is set to the reference whereby the inspection is conducted.

In contrast, in the case where an operator has inspected a recording medium having an image actually formed thereon and has judged the medium as good, the operator sets, as a reference, image data obtained by scanning the image on this recording medium. Then, there is a method of using this reference and inspecting a recording medium having formed thereon an image to be inspected. In this method, since the scanned image data obtained by scanning the image actually formed on a recording medium is used as the reference, inspection can be performed taking into consideration a variation in color among a plurality of images. However, it is complicated to manually set the recording medium as the reference after an operator visually inspects the recording medium.

### SUMMARY OF THE INVENTION

A device according to the present invention comprises: a scanning unit configured to scan a printed material obtained by printing image data; a setting unit configured to set reference data based on the image data; and a determining unit configured to determine whether a printed material is proper by comparing the image data obtained by the scan with the reference data, wherein the setting unit sets again the reference data based on the image data obtained by the scan for a subsequent printed material in a case where the determining unit determines a printed material to be proper.

According to the present invention, there can be performed quality inspection having less complexity than the related art processing, on an image on a recording medium.

Further features of the present invention will become apparent from the following description of exemplary embodiments (with reference to the attached drawings).

### BRIEF DESCRIPTION OF THE DRAWINGS

FIG. 1 is a view showing a configuration example of an inspection system according to an embodiment of the present invention;

FIG. 2 is a block diagram showing the configuration of an image forming device;

FIG. 3 is a view showing a mechanical configuration of the image forming device;

FIGS. 4A and 4B are views showing mechanical configurations of an inspection device;

FIG. 5 is a view showing a functional configuration in an inspection processing unit of the inspection device;

FIG. 6 is a view showing a configuration example of a finisher unit;

FIG. 7 is a view showing the functional configuration of the finisher unit;

FIG. 8 is a flow chart showing the procedure of an inspection processing in a present Embodiment 1;

FIG. 9 is a flow chart showing the procedure of an inspection processing in printing one copy in the present Embodiment 1;

FIG. 10 is a flow chart showing the procedure of an inspection processing in printing a plurality of copies in the present Embodiment 1;

FIGS. 11A and 11B are views showing an example of inspection determination criteria, related to the present Embodiment 1;

FIG. 12 is a flow chart showing the procedure of an inspection processing in a present Embodiment 2;

FIG. 13 is a flow chart showing the procedure of an inspection processing for variable printing in the present Embodiment 2; and

FIGS. 14A and 14B are views for illustrating a method of generating reference image data of a variable area related to the present Embodiment 2.

### DESCRIPTION OF THE EMBODIMENTS

### Embodiment 1

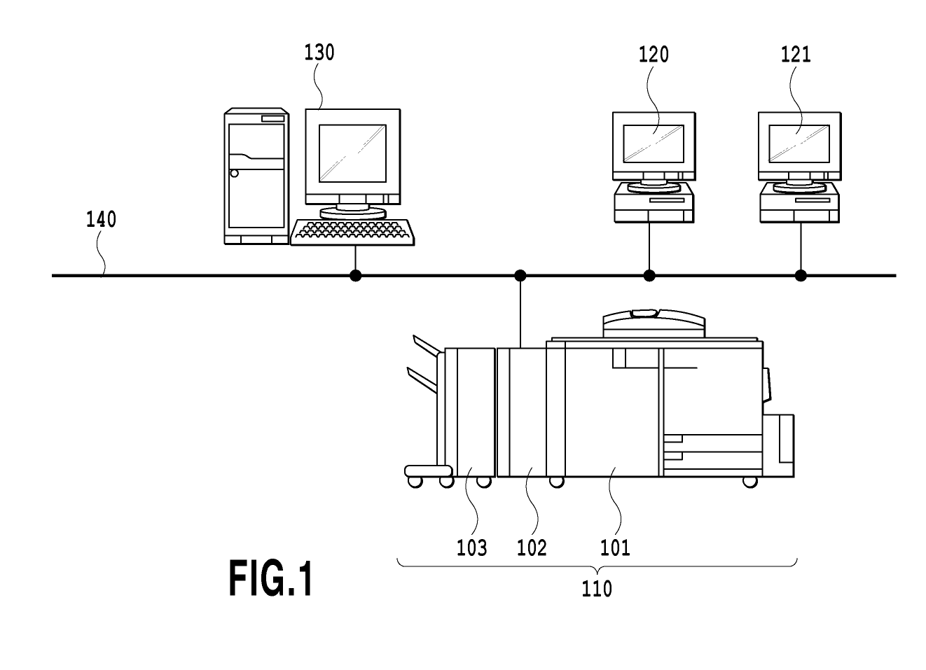

Hereinafter, the best mode for carrying out the present invention will be described with reference to the accompanying drawings. FIG. 1 shows a configuration example of an image inspection system including an inspection device according to an embodiment of the present invention.

The image inspection system includes a device 110, a client PC 120, a client PC 121, a print server 130, and a network 140.

The device 110 includes an image forming device 101, an inspection device 102, and a finisher unit 103. The device 110 employs an in-line inspection scheme in which the image forming, image inspection, and finishing are consistently performed.

The image forming device 101 processes various kinds of input data, prints out an image onto a recording medium, such as a sheet. The inspection device 102 receives a print output from the image forming device 101, and inspects whether or not the quality of an image on a recording medium satisfies a certain criterion. The finisher unit 103 receives the recording medium inspected by the inspection device 102, and discharges the same to the outside.

The device 110 is connected to the print server 130 and the client PC 120 and client PC 121 via the network 140.

### [Configuration of Image Forming Device]

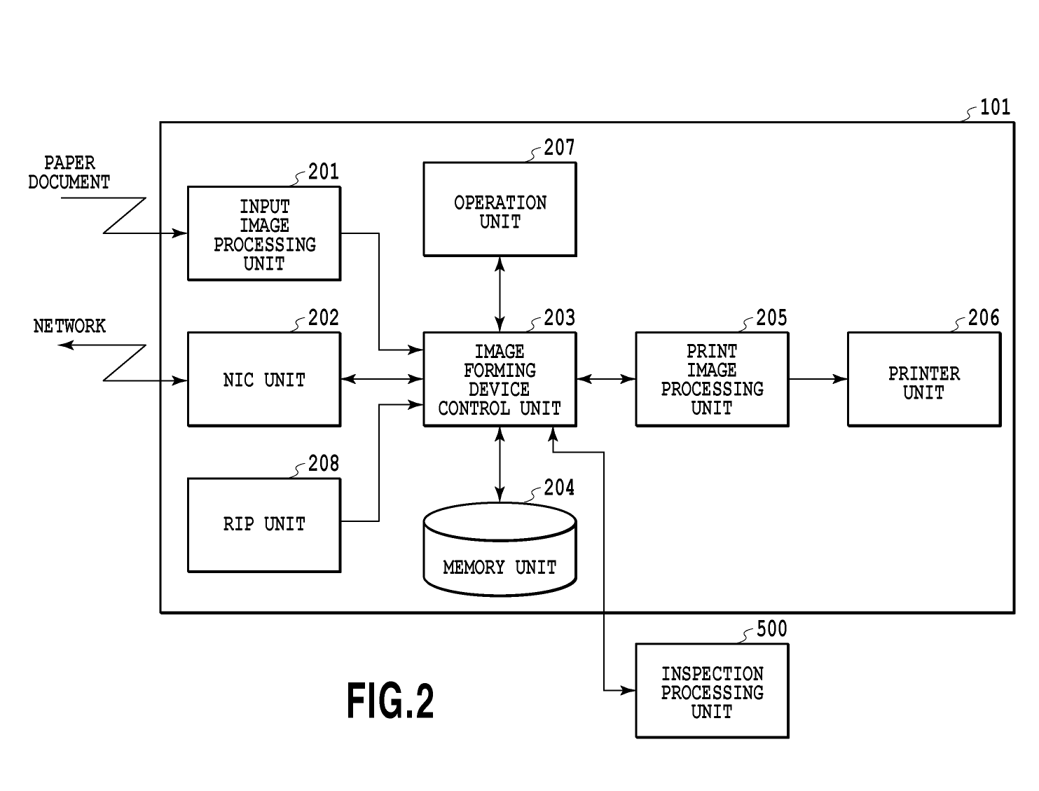

FIG. 2 is a diagram showing an example of the configuration of the image forming device 101. Note that each processing which the image forming device 101 performs is comprehensively controlled by an image forming device control unit 203.

In FIG. 2, the input image processing unit 201 reads a sheet document or the like with an image reading device such as a scanner, and creates image data. Then, the image data is sent to the image forming device control unit 203.

A NIC unit 202 is a NIC (Network Interface Card) for transmitting the image data and device information inside the image forming device to the outside via the network.

An image forming device control unit 203 serving to control the data to be input and the data to output, wherein the control by a non-illustrated CPU (Central Processing Unit) is performed. The image data having been input to the image forming device control unit 203 is once stored into a memory unit 204. The stored image data is temporarily held, and is called up as required.

Furthermore, the image forming device control unit 203 is connected to the inspection processing unit 500 of the inspection device 102, and transmits/receives information required for the inspection processing by the inspection processing unit 500. Moreover, the image forming device control unit 203 transmits/receives printout timing information, reference image data, a setting value required for inspection, and information of the result of the inspection processing so that the inspection device 102 can perform the inspection processing in association with a print job which has been subjected to the print processing by the image forming device 101.

A print image processing unit 205 performs a print image processing for printing, and sends the processed image to a printer unit 206. This print image processing includes a color space conversion processing, a halftone processing, gamma correction, edge enhancement, resolution conversion, and the like.

The printer unit 206 feeds a sheet serving as a recording medium, and sequentially prints the image data created by the print image processing unit 205 onto the sheet. The printed sheet is discharged from the printer unit 206, and sent to the inspection device 102.

An operation unit 207 is used for selecting and indicating a function a user tries to use, among the functions which the image forming device 101 has. The operation unit 207 includes, for example, a liquid crystal display (LCD), or a touch panel employing a capacitance system or the like.

A RIP unit 208 (Raster Image Processor) decodes input PDL data, and expands this data to bit map data capable of being printed and/or displayed, and generates RIP image data.

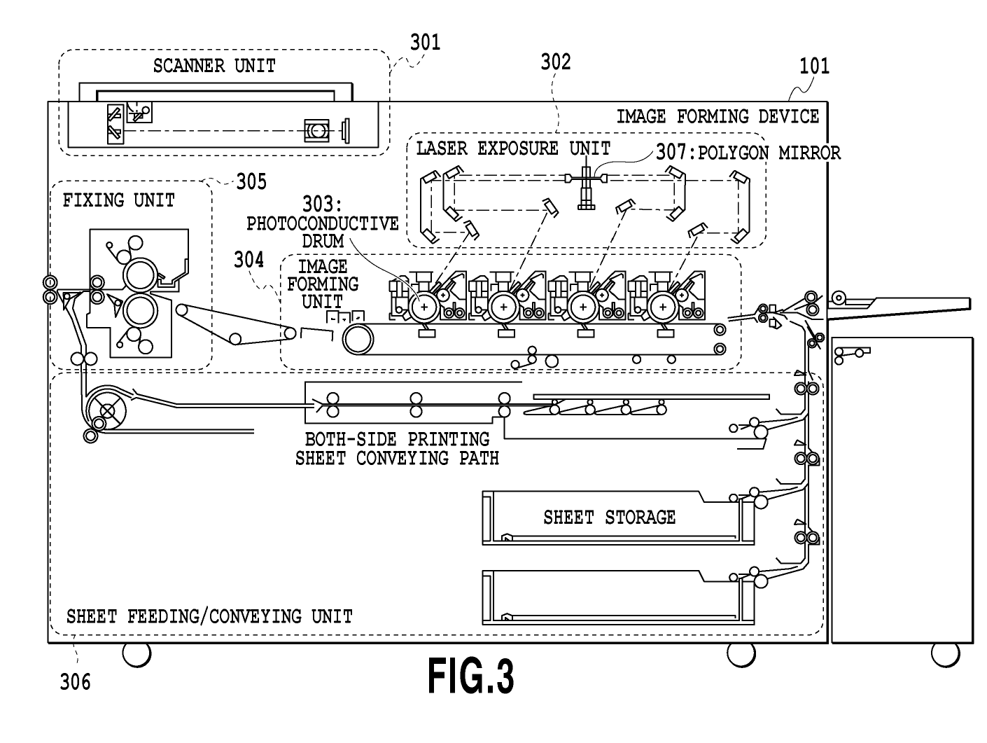

FIG. 3 is a view showing the mechanical configuration of the image forming device 101.

The image forming device 101 includes a scanner unit 301, a laser exposure unit 302, a photoconductive drum 303, an image forming unit 304, a fixing unit 305, a sheet feeding/conveying unit 306, and an image forming device control unit 203 for controlling these units and drum.

The scanner unit 301 emits light to a document placed on a document table, optically reads an image on a document, and converts this image to an electric signal, to thereby create image data.

The laser exposure unit 302 causes a light beam such as a laser beam modulated in accordance with the created image data, to be incident upon a rotating polygon mirror (polygon mirror) 307 rotating at a constant angular velocity, thereby irradiating the photoconductive drum 303 with the resulting light beam as reflective scanning light.

The image forming unit 304 rotationally drives the photoconductive drum 303 to thereby be charged with a charger, and develops a latent image formed on the photoconductive drum by the above-described laser exposure unit, by using a toner. The development is realized by having a quadruple development unit (development station) that performs a series of electrophotographic processes such as transferring the toner image onto a sheet and collecting micro toners that remains on the photoconductive drum without being transferred. The quadruple development unit arranged in the order of Cyan (C), Magenta (M), Yellow (Y), and Black (K) performs sequentially the image forming operations of Magenta, Yellow, and Black after the elapse of a predetermined period of time from the start of forming an image at the cyan station. With this timing control, a full-color-toner image without color deviation is transferred onto a sheet. The present embodiment assumes a color printer, but not limited thereto, and in the case of a monochrome printer, only the development unit of black is mounted.

The fixing unit 305 includes a combination of rollers and belts, incorporates a heat source such as a halogen heater, and the toner on a sheet onto which a toner image is transferred by the above-described image forming unit, is melted and fixed with heat and pressure. The sheet feeding/conveying unit 306 has one or more sheet storages represented by a sheet cassette or a sheet deck, separates one sheet among a plurality of sheets housed in the sheet storage in accordance with an instruction from the above-described printer control unit, and conveys the same to the image forming unit 304 and the fixing unit 305. The sheet is conveyed, and the toner image for each color is transferred by the above-described development station and finally a full-color toner image is formed on the sheet. Furthermore, in the case of forming an image on both sides of a sheet, the control is made so that the sheet having passed through the fixing unit 305 passes through a conveyance path for conveying the sheet again to the image forming unit 304. The image forming device control unit 203 controlling the whole image forming device, communicates with each unit shown in FIG. 2 to execute control in accordance with its instruction. In addition, the image forming device control unit 203 manages the state of each of the above-described scanner, laser exposure unit, forming unit, fixing unit, and sheet feeding/conveying unit, and issues instructions so that the whole image forming device can maintain harmony and smoothly operate.

### [Configuration of Inspection Device]

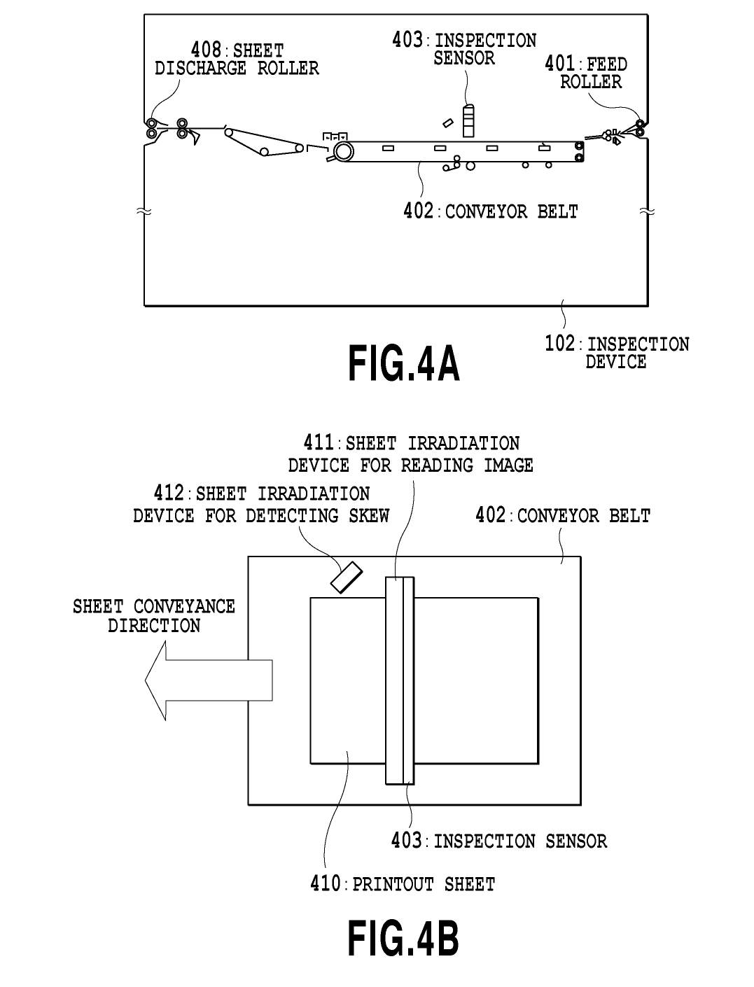

FIG. 4A is a view schematically showing the mechanical configuration of the inspection device 102.

A sheet printed out from the image forming device 101 is pulled into the inspection device 102 by a sheet feed roller 401. Subsequently, the printed-out sheet is transferred on a conveyor belt 402, the image on the sheet is read by an inspection sensor 403 on the conveyor belt 402, and the quality of the image on the sheet is determined.

The determination result is sent to the finisher unit 103. After the determination is made, a sheet 410 is output from a sheet discharge roller 404. Although not illustrated here, the inspection sensor 403 may be configured to read also from under the conveyor belt 402 so as to be able to also deal with a both-side printing sheet.

FIG. 4B is a view showing an example of a top view of the portion of the conveyor belt 402, and here the inspection sensor 403 is a line sensor that reads, for each line, the image of the entire surface of the conveyed sheet 410 as illustrated.

A sheet irradiation device for reading an image 411 irradiates a sheet with light in the case where an image is read on the sheet by the inspection sensor 403.

A sheet irradiation device for detecting skew 412 detects whether or not a sheet is skewed with respect to the conveying direction in the case where the sheet is conveyed on the conveyor belt 402. By irradiating a sheet to be conveyed from a diagonal direction, reading of an image of the shadow at an edge of the sheet is performed to detect the skew. In the present embodiment, the reading of the shadow image of the sheet edge is performed by the inspection sensor 403, but other read sensor except the inspection sensor 403 may be used.

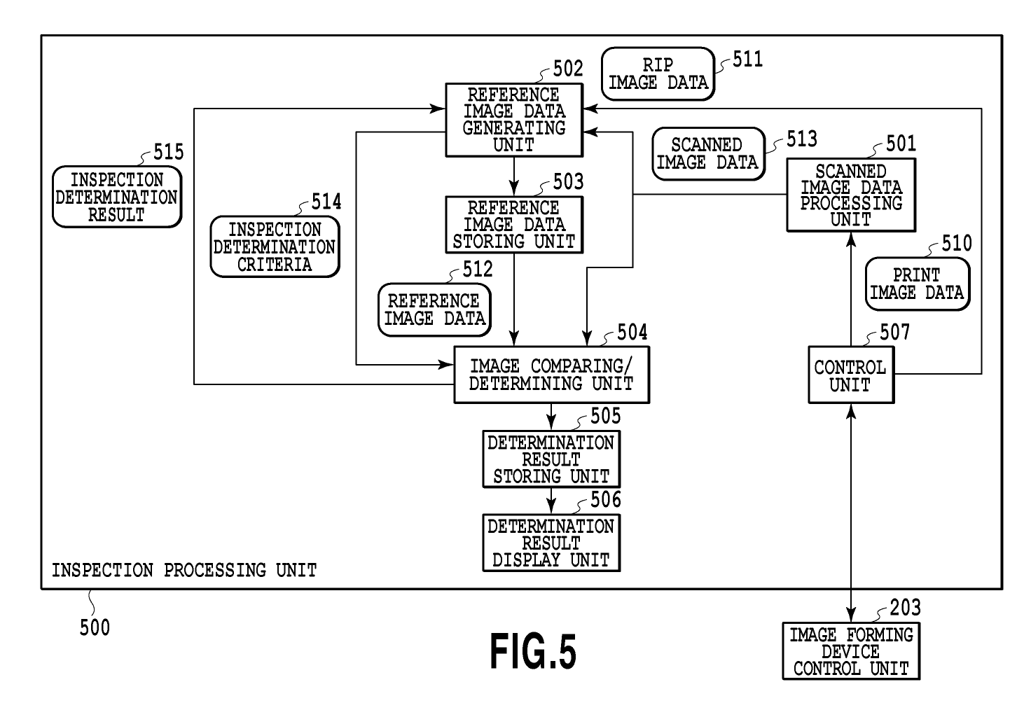

FIG. 5 is a view showing the functional configuration of the inspection processing unit 500 which the inspection device 102 includes.

The inspection processing unit 500 performs controls for generating reference image data based on RIP image data or scanned image data and for performing inspection processing on a printed image. Note that these inspection processing is comprehensively controlled by a control unit 507.

The scanned image data processing unit 501 generates scanned image data 513 by performing, as a pre-correction processing, a scanned image processing on print image data obtained by converting, into an electric signal, the image on a sheet read by the inspection sensor 403. The scanned image processing includes the processing such as sheet skew correction, color correction processing, edge enhancement, and resolution conversion. Here, the color correction processing is for performing color correction of a reading device of the inspection sensor 403, and for converting into a standard color space and generating a scanned image.

A reference image data generating unit 502 receives RIP image data 511 or scanned image data 513 sent from the image forming device control unit 203, and generates reference image data 512.

The reference image data generating unit 502 can also execute, for the RIP image data, print image processing corresponding to the setting of a print job or image processing, for print data, that corresponds to the scanned image processing. Therefore, as compared with the case where the RIP image data is used as it is for the reference image data, there can be generated the reference image data having a smaller difference in density and/or in characteristics than the print image data to be inspected. Note that the reference image data generating unit 502 determines, based on an inspection determination result 515 received from an image comparing/determining unit 504 to be described later, whether or not the scanned image data 513 is used for generation of the reference image data.

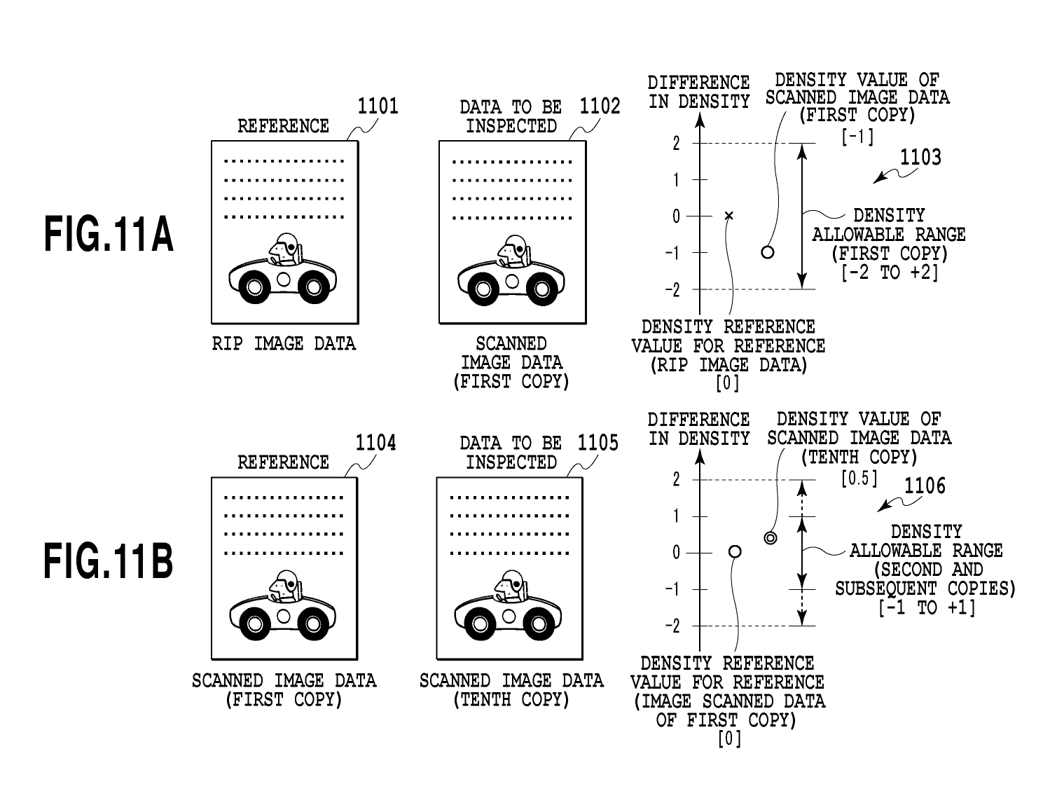

Furthermore, the reference image data generating unit 502 determines and generates inspection determination criteria 514 for the generated reference image data. For example, as the inspection determination criteria for density, a density allowable range (a threshold range) is determined. That is, in the case where the density value of scanned image data is within a determined density allowable range, the determined density allowable range serves as the criteria for determining as an image having a certain quality. Note that the inspection determination criteria will be described later using FIGS. 11A and 11B.

A reference image data storing unit 503 stores the reference image data generated by the reference image data generating unit 502. In the case of printing a plurality of copies, the reference data stored in the reference image data storing unit 503 can be read and used for each copy.

The image comparing/determining unit 504, first, compares the reference image data 512 generated by the reference image data generating unit 502 with the scanned image data 513 to be inspected generated by the scanned image data processing unit 501. Then, from the comparison result, the equivalence of the print image data with respect to the reference image data is determined in accordance with the inspection determination criteria 514 determined by the reference image data generating unit 502.

Moreover, the image comparing/determining unit 504 sends an inspection determination result 515 to the reference image data generating unit 502 and causes the reference image data generating unit 502 to update the reference image data and/or the inspection determination criteria. The updating of the inspection determination criteria will be described later using FIGS. 11A and 11B.

In the case where, as a result of the determination by the image comparing/determining unit 504, the reference image data and the print image data are determined as not being equivalent, a determination result storing unit 505 stores the page information, inspection determination content, and the like of a corresponding page. The stored determination result is made available as a database as the result of inspection processing.

A determination result display unit 506 displays, to a user, the determination result stored in the determination result storing unit 505.

A control unit 507 performs various kinds of control processing of the inspection device 102, and also transfers image data and/or print job data to/from the image forming device control unit 203 inside the image forming device 101. Furthermore, the control unit 507 notifies the image forming device control unit 203, of the determination result of the above-described inspection processing, and the image forming device control unit 203 controls the operation of the image forming device 101 in accordance with whether the determination result is good or bad.

### [Configuration of Finisher]

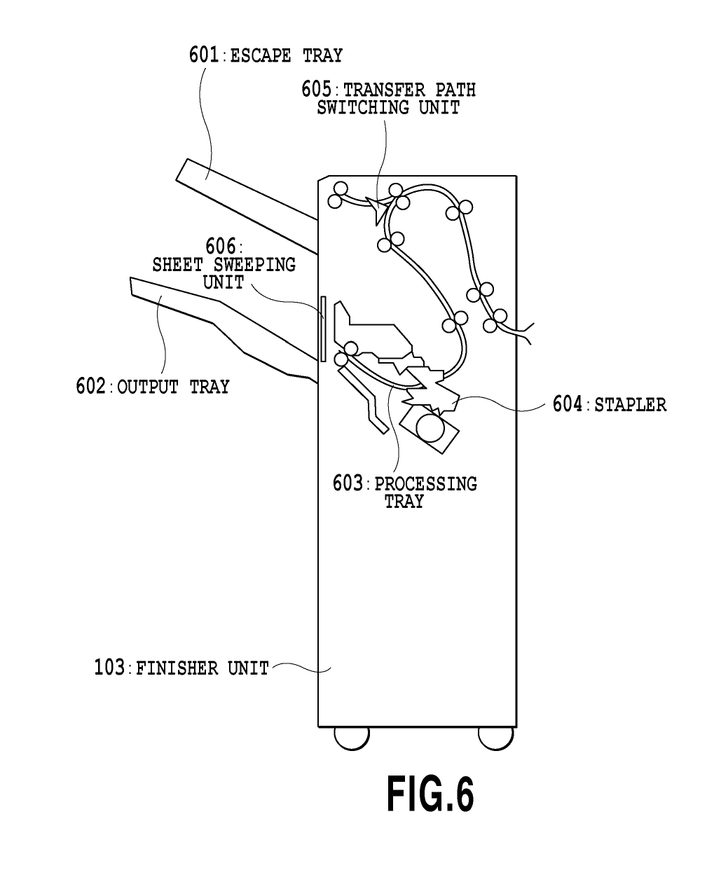

FIG. 6 is a cross-sectional view of an example of the configuration of the finisher unit 103.

A sheet discharged from the inspection device 102 enters the finisher unit 103. The finisher unit 103 includes an escape tray 601 and an output tray 602, which are switched in accordance with the determination result of the inspection device 102, to discharge a sheet. Furthermore, in the case where a staple mode is set for a job to output, the finisher unit 103 performs control so as to discharge a sheet to the output tray. In such a case, before the sheets are discharged to the output tray, they are sequentially stored into a processing tray 603 inside the finisher unit for each job, and on the processing tray 603, the sheets are bound by a stapler 604, and thereafter this recording sheet bundle is discharged to the output tray 602.

A transfer path switching unit 605 switches the transfer paths of a printout sheet in accordance with the inspection determination information from the inspection device 102. Switching of the transfer paths allows a printout sheet to be transferred to the escape tray 601 or to the output tray 602.

A sheet sweeping unit 606 performs, on the sheets discharged onto the output tray, a shift operation in a direction perpendicular to the sheet discharge direction. In the case where the sheet sweeping unit 606 operates, the discharged sheets are shifted relative to the case where the sheet sweeping unit 606 does not operate, thereby allowing the shifted discharged sheets to be discharged in distinction from other discharged sheets.

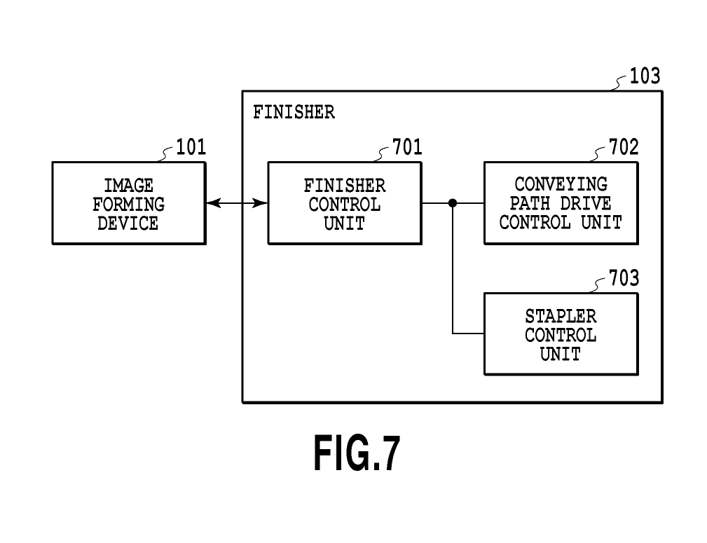

FIG. 7 is a view showing the functional configuration of the finisher unit 103.

The image forming device control unit 203 of the image forming device 101 and a finisher control unit 701 inside the finisher unit 103 are connected by a dedicated communication line.

The finisher control unit 701 receives finisher setting information corresponding to a job from the image forming device 101, and communicates with a control unit that controls each function inside the finisher unit 103 based on the received setting information.

A conveying path drive control unit 702 guides a sheet to various finishing units based on the control information of a job transmitted from the finisher control unit 701. For example, in the case where a user wants to perform output of stapled sheets, the conveying path drive control unit 702 communicates with the stapler control unit 703, the finisher control unit 701 receives status information of the stapler control unit 703 and transmits the control information of the job, and then outputs the sheets after performing a stapler operation in accordance with the content of the job.

### [Inspection Flow]

As the present embodiment, in the above-described image inspection system, there will be described the procedure of the inspection processing using the RIP image data generated based on a print job and the scanned image data generated by scanning a sheet printed in accordance with to the relevant print job.

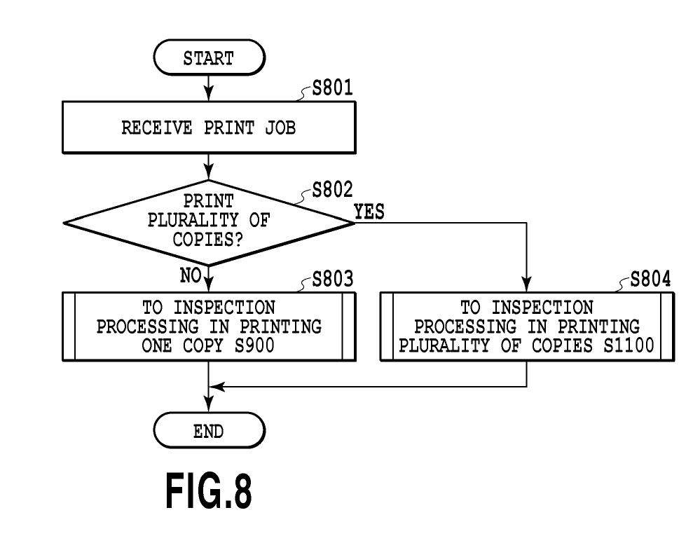

FIG. 8 is a flow chart showing the procedure of the inspection processing in a present Embodiment 1.

First, in S801, the image forming device control unit 203 receives a print job via the NIC unit 202. Note that, this print job includes, for example, input image data, and the information indicative of the contents such as the number of copies, the number of pages, and the content of an image processing. Then, the image forming device control unit 203 transmits this print job to the inspection processing unit 500.

In S802, the image forming device control unit 203 determines whether or not this print job is for printing a plurality of copies. The determination is made with reference to the information of the number of copies which the print job received in S801 includes.

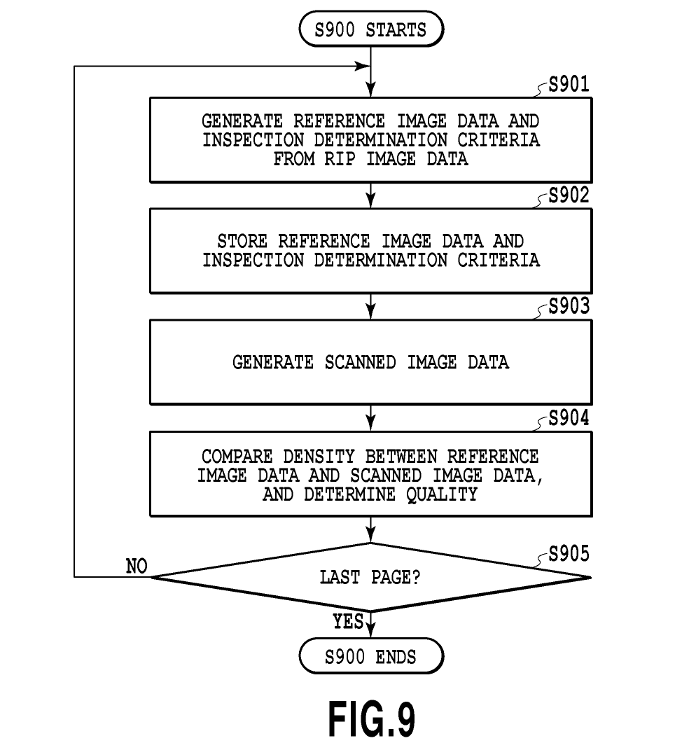

As a result of the determination, in the case where the print job is not the same print job related to printing a plurality of copies (i.e., in the case of a print job indicative of printing one copy) (S802; NO), the image forming device control unit 203, in S803, causes the inspection device 102 to execute inspection processing S900 for a print job of printing one copy (FIG. 9).

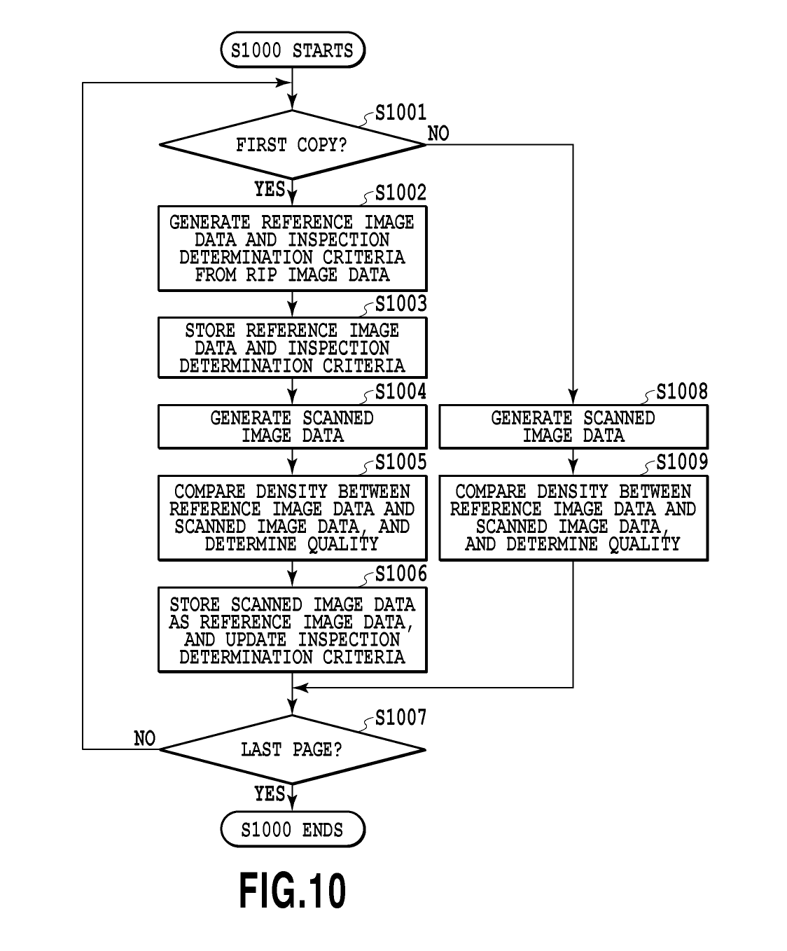

In contrast, in the case where the print job is determined as the one for printing a plurality of copies (S802; YES), the image forming device control unit 203, in S804, causes the inspection device 102 to execute inspection processing S1000 (the processing shown in FIG. 10) for a job of printing a plurality of copies.

FIG. 9 is a flow chart showing the procedure of the inspection processing for the job of printing one copy, which the inspection processing unit 500 inside the inspection device 102 performs, in the present Embodiment 1. Note that the inspection processing S900 for printing one copy is executed by the control unit 507 inside the inspection processing unit 500.

First, in S901, the control unit 507 transmits, to the reference image data generating unit 502, the RIP image data related to a print job transmitted from the image forming device control unit 203. Then, the reference image data generating unit 502 sets the RIP image data as the reference image data.

Note that the reference image data generating unit 502 may set the received RIP image data as it is as the reference image data. Alternatively, the reference image data generating unit 502 can also set, as the reference image data, the RIP image data in which the received RIP image data has been further image-processed, based on the influence from the printing processing to be performed on the basis of a print job received by the inspection processing unit 500 or based on scanner characteristics. Therefore, there can be formed the reference image data in which the color tinge and density of an image actually formed on a recording medium are taken into consideration.

Whether the reference image data generating unit 502 uses the RIP image data as it is as the reference image data or subjects the RIP image data to image processing may be set by a user when a print job is input. Alternatively, the inspection processing unit 500 may set this in accordance with the print job information.

Furthermore, in S901, the reference image data generating unit 502 also determines inspection determination criteria for the generated reference image data. The inspection determination criteria will be described in detail later using FIGS. 11A and 11B.

In S902, the control unit 507 causes the reference image data storing unit 503 to store the reference image data and the inspection determination criteria, generated in S901.

In S903, the control unit 507 causes the scanned image data processing unit 501 to scan a sheet printed by the image forming device 101 based on a print job, and generate scanned image data.

In S904, the control unit 507 reads the reference image data stored in the reference image data storing unit 503, and compares the density between this reference image data and the scanned image data generated by the scanned image data processing unit 501. Then, based on the inspection determination criteria stored in the reference image data storing unit 503 in the same way, the control unit 507 determines the quality of the image output onto a sheet. Note that there will be described later using FIGS. 11A and 11B the detail of the quality determination based on the inspection determination criteria.

In S905, the control unit 507 determines whether or not the print job up to the last page has been completed. In the case where the print job has not reached the last page (S905; NO), the processing from S901 to S904 is repeatedly performed. In contrast, in the case where the print job has reached the last page (S905; YES), the inspection processing ends.

Subsequently, FIG. 10 is a flow chart showing the procedure of the inspection processing in printing a plurality of copies, the inspection processing being executed by the control unit 507 of the inspection processing unit 500 inside the inspection device 102, in the present embodiment.

First, in S1001, the control unit 507 determines whether or not a received print job is the processing related to the first printed material in starting to print a plurality of copies. In the case where the processing is determined as the one for the first printed material (S1001; YES), the procedure moves to the flow of S1002. In contrast, in the case where the received print job is the processing for the second and subsequent printed materials (S1001; NO), the procedure moves to the flow of S1008.

Here, each of the steps in the processing flow from S1002 to S1005 in the inspection processing for the first printed material in printing a plurality of copies is the same as each of the steps in the processing flow from S901 to S904 in the above-described inspection processing in printing one copy, and thus the description thereof is omitted.

Subsequently, in S1006, the control unit 507 newly generates the reference image data used for determining the quality of the second and subsequent printed materials.

In this case, the control unit 507 causes the reference image data storing unit 503 to store the scanned image data determined as being good in the inspection processing for the first copy, via the reference image data generating unit 502. Then, the reference image data generating unit 502 sets this scanned image data to the reference image. Moreover, in accordance with the change of the reference image data, the reference image data generating unit 502 updates the inspection determination criteria and stores the resulting criteria into the reference image data storing unit 503. The updating of the inspection determination criteria will be described later using FIGS. 11A and 11B.

Finally, in S1007, it is determined whether or not the print job has been completed up to the last copy. In the case where the print job has not reached the last copy (S1007; NO), the procedure returns to S1001. In contrast, in the case where the print job has reached the last copy (S1007; YES), the inspection processing ends.

Next, the procedure for the second and subsequent printed materials in printing a plurality of copies will be described. In S1001, in the case where the inspection processing of starting execution is determined as not the processing for the first printed material (S1001; NO), the procedure proceeds to S1008, where the quality of the second and subsequent printed materials is determined.

In S1008, as with S1004, the scanned image data processing unit 501 scans a printed material to generate scanned image data.

Next, in S1009, the scanned image data processing unit 501 reads the reference image data stored in the reference image data storing unit 503, and compares the density between the read reference image data and the scanned image data generated by the scanned image data processing unit 501. The reference image data used here is the scanned image data, the quality of which with respect to the first printed material has been determined as being good in S1006. Then, the image comparing/determining unit 504 reads the inspection determination criteria which is updated and stored in S1006, from the reference image data storing unit 503, and determines the quality based on the read inspection determination criteria.

### [Method of Determining Inspection Determination Criteria]

Next, the detail of the inspection determination criteria in the present embodiment will be described using FIGS. 11A and 11B.

FIG. 11A is a view for illustrating a specific example of the quality determination using the inspection determination criteria in Step S901 to S904 of FIG. 9 and in S1002 to S1005 of FIG. 10.

First, the reference image data generating unit 502 calculates the density of RIP image data 1101 which is the reference image data of the first copy, and sets the calculated density to a density reference value. Then, the reference image data generating unit 502 sets a density allowable range for determining, through the comparison between both image data, whether the relevant scanned image data is good or bad.

For example, as shown by a graph 1103, the density of the reference image data (the RIP image data in the inspection processing of the first printed material) is set to “0” serving as a density reference value, and the density allowable range is set to “−2 to +2”. This set density allowable range is referred to as inspection determination criteria in the present embodiment. That is, the density allowable range is determined by the inspection determination criteria.

For the density allowable range, in a relationship between the RIP image data 1101 that is the reference image data corresponding to the first printed material, and scanned image data 1102 to be inspected, there is required to be set the density allowable range in which the image processing according to the setting of a print job is taken into consideration. That is, the density allowable range may not necessarily be based on the reference value of the density of the RIP image data.

For example, in the case where the density of scanned image data becomes deep (darker) due to the print image processing and the scanned image processing, the density allowable range may be set to “−10 to −6”. Furthermore, in the case where these image processing is not taken into consideration, the density allowable range may be set to “−10 to +10”, i.e., set to be wider than the density allowable range in the inspection processing of the second and subsequent printed materials to be described later.

Next, the image comparing/determining unit 504 calculates a density difference between the scanned image data 1102 of a printed-material to be inspected and the RIP image data 1101 that is the reference image data, and determines whether or not the calculated density difference is within the density allowable range.

For example, like a graph 1103 shown in FIG. 11A, in the case where the value of the density difference between the RIP image data 1101 and the scanned image data 1102 has been calculated as “−1”, the density difference is within “−2 to +2” of the density allowable range. The image comparing/determining unit 504 determines the scanned image data 1102 to be inspected, as being good in the case where the density value thereof is within the density allowable range.

In the case of the density difference exceeding the density allowable range, the image comparing/determining unit 504 determines the image of a printed-material to be inspected, as being bad. That is, it is assumed that a printing failure of the printer unit 206 or a setting error of a print job causes an abnormal density in the scanned image data of a printed-material to be inspected.

FIG. 11B is a view for illustrating the determination of inspection determination criteria and the quality determination using the inspection determination criteria in the inspection processing of the second and subsequent copies in printing a plurality of copies in Steps 1006 to S1009 of FIG. 10. Here, there will be described a case where the tenth copy is set to be inspected.

In the case where the result of the quality determination of the first copy is good, the image comparing/determining unit 504 transmits the scanned image data 1102 of the first copy to the reference image data storing unit 503. Then, reference image data of the second and subsequent copies is set to reference image data 1104 obtained by being replaced (set again) with the scanned image data 1102.

Moreover, the image comparing/determining unit 504 updates the inspection determination criteria based on the result of the quality determination of the first copy. For example, as shown in a graph 1106, the density of the scanned image data of the first printed material which is the new reference image data 1104 is set as the density reference value “0”. Then, a range of “−1 to +1” narrower than the density allowable range that has been used in the inspection processing of the first printed material, is set to a new density allowable range.

In this way, in the inspection determination of the second and subsequent printed materials, the scanned image data of the first copy subjected to the print image processing corresponding to the setting of a print job or subjected to the scanned image processing by the inspection device can be used as new reference image data. As a result, the inspection can be made using a severer density allowable range for a fluctuation in the density.

For example, as shown by the graph 1106, in the case where the density difference of scanned image data 1105 of the tenth copy has been calculated as “0.5”, the inspection is determined as “OK” because the density difference is within the density allowable range of “−1 to +1”. In the case where in the inspection of the second and subsequent copies, the density difference exceeding the density allowable range is caused in the scanned image data 1105, the image comparing/determining unit 504 determines the printed-material to be inspected, as being bad. That is, it is assumed that an abnormality of the printing of the printer unit 206, the inspection sensor of the inspection device 102, or the like has caused a fluctuation in the density for each copy.

As described above, in the inspection processing in printing a plurality of copies, by changing the reference image data depending on what number printed-material to be inspected is inspected and by setting of inspection determination criteria corresponding to the changed reference image data, high-precision inspection becomes possible.

### Embodiment 2

### Inspection Processing

In Embodiment 2, in an image inspection system similar to that of Embodiment 1, there will be described inspection processing by using reference image data generated using both the RIP image data and the scanned image data. Note that, in Embodiment 2, template data that can be re-used commonly among a plurality of pages and variable data that is an image of a type different for each page are combined by an image processing unit, and the processing related to variable printing for printing the combined data is performed.

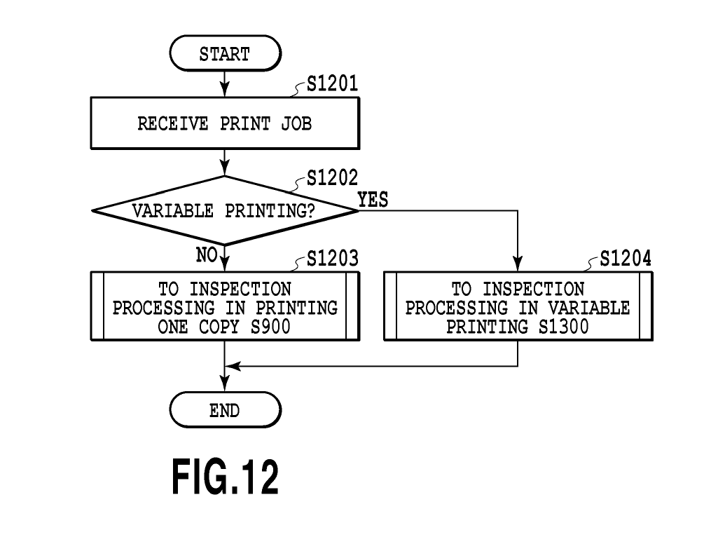

FIG. 12 is a flow chart showing the procedure of the inspection processing in Embodiment 2.

First, in S1201, the NIC unit 202 receives a print job. In this case, the information related to the print job includes input image data, and the information related to job setting, such as the number of copies, the number of pages, and the content of image processing. The print job received by the NIC unit 202 is transferred to the inspection processing unit 500.

Next, in S1202, the image forming device control unit 203 determines whether or not the content of the print job indicates variable printing. The determination can be made based on the content which the variable printing information included in the print job received in S1201 indicates.

In the case where the image forming device control unit 203 determines that the received print job does not indicate the variable printing (S1202; NO), then in S1203, the image forming device control unit 203 causes the inspection processing unit 500 to execute the inspection processing S900 for a one-copy printing job. The inspection processing S900 for this one-copy printing job is the same processing as the inspection processing in printing one copy described in Embodiment 1.

In contrast, in the case where the image forming device control unit 203 determines that the received print job indicates the variable printing (S1202; YES), then in S1204, the image forming device control unit 203 causes the inspection processing unit 500 to execute inspection processing S1300 for the variable printing job.

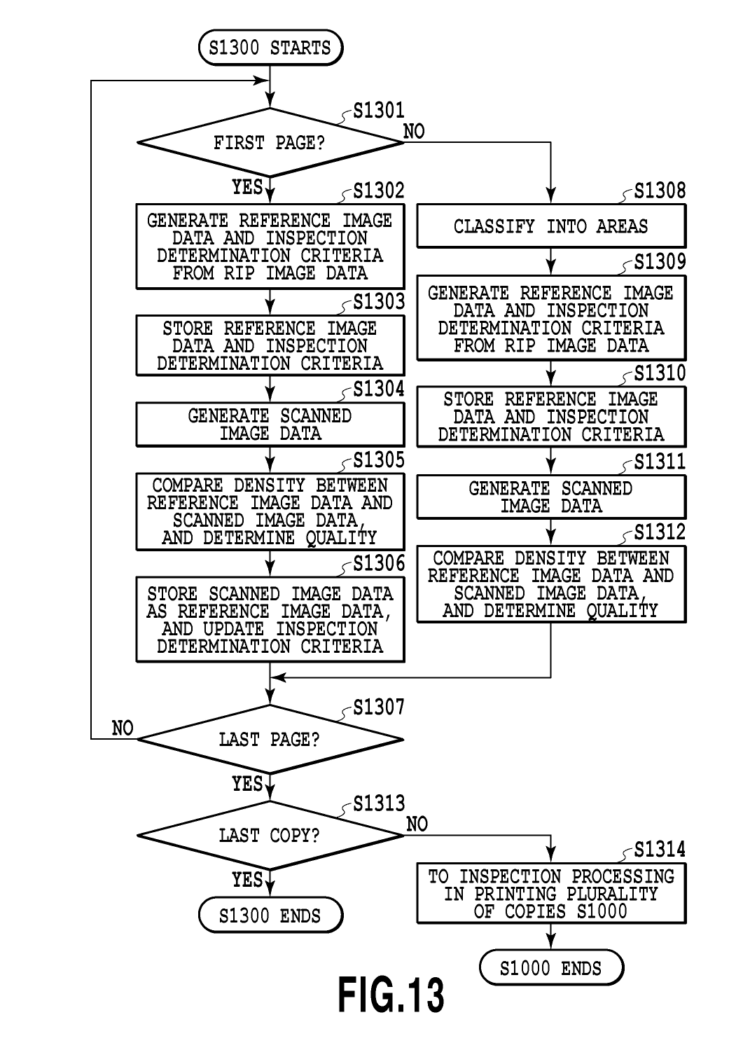

FIG. 13 is a flow chart showing the procedure of the variable printing inspection processing (S1300) executed by the control unit 507 of the inspection processing unit 500 inside the inspection device 102, in the present Embodiment 2.

First, in S1301, the control unit 507 determines, for the received print job, whether or not the processing is the one for the first page in variable printing. Here, in the case where the control unit 507 determines that the processing is the one related to the first page in variable printing (S1301; YES), the procedure proceeds to S1302. In contrast, in the case where the processing is the one related to the second and subsequent pages in variable printing (S1301; NO), the procedure proceeds to S1308.

Here, the flow from S1302 to S1305 in the inspection processing for the first page in printing a plurality of copies is the same as the flow from S1002 to S1005 described in Embodiment 1, and thus the description thereof is omitted.

Then, in S1306, the control unit 507 stores, into the reference image data storing unit 503, the scanned image data which has been determined as being good by the inspection determination of the first page, as the reference image data also used for the second and subsequent pages. Moreover, in accordance with the change of the reference image data, the inspection determination criteria are updated and stored into the reference image data storing unit 503.

Finally, in S1307, the control unit 507 determines whether or not the print job has been completed up to the last page. In the case where the print job has not reached the last page (S1307; NO), the procedure returns to S1301. In contrast, in the case where the print job has reached the last page (S1307; YES), in S1313, the control unit 507 determines whether or not the print job has been completed up to the last copy. In the case where the print job has not reached the last copy (S1313; NO), the print job serves for the print job for variable printing of a plurality of copies, and thus, in S1314, the procedure moves to the inspection processing S1000 in printing a plurality of copies shown in Embodiment 1. On the other hand, in the case where the print job has reached the last copy (S1313; YES), the inspection processing is completed.

Next, a flow in the inspection processing for the second and subsequent pages in variable printing will be described. In S1301, in the case where it is determined that the inspection processing of starting execution is not the processing for the first page (S1301; NO), in S1308, the control unit 507 classifies the RIP image data of the second page into a variable area and a template area. This classification is conducted based on variable template area information which a variable printing job included in the print job received in S1201 indicates.

In S1309, the control unit 507 generates reference image data in which a variable area in the reference image data stored in the reference image data storing unit 503 is replaced with the variable area of the RIP image classified in S1308. At the same time, the control unit 507 creates inspection determination criteria related to the new reference image data, and updates also the inspection determination criteria for the second and subsequent pages by being replaced with this created inspection determination criteria. Note that the reference image data generation method in S1309 will be described later.

Next, in S1310, the control unit 507 causes the reference image data storing unit 503 to store the reference image data and the inspection determination criteria, generated in S1309.

In S1311, as with S1304, the scanned image data processing unit 501 scans a printed material to generate scanned image data. Then, in S1312, the image comparing/determining unit 504 reads out the reference image data stored in the reference image data storing unit 503, and compares the density between the reference image data and the scanned image data generated by the scanned image data processing unit 501.

As described above, in variable printing, as to the second and subsequent pages, only the variable area of a RIP image can be replaced using the scanned image data of the first page as the reference image data, and thus effective density inspection processing becomes possible.

### [Reference Generation Method in Variable Printing]

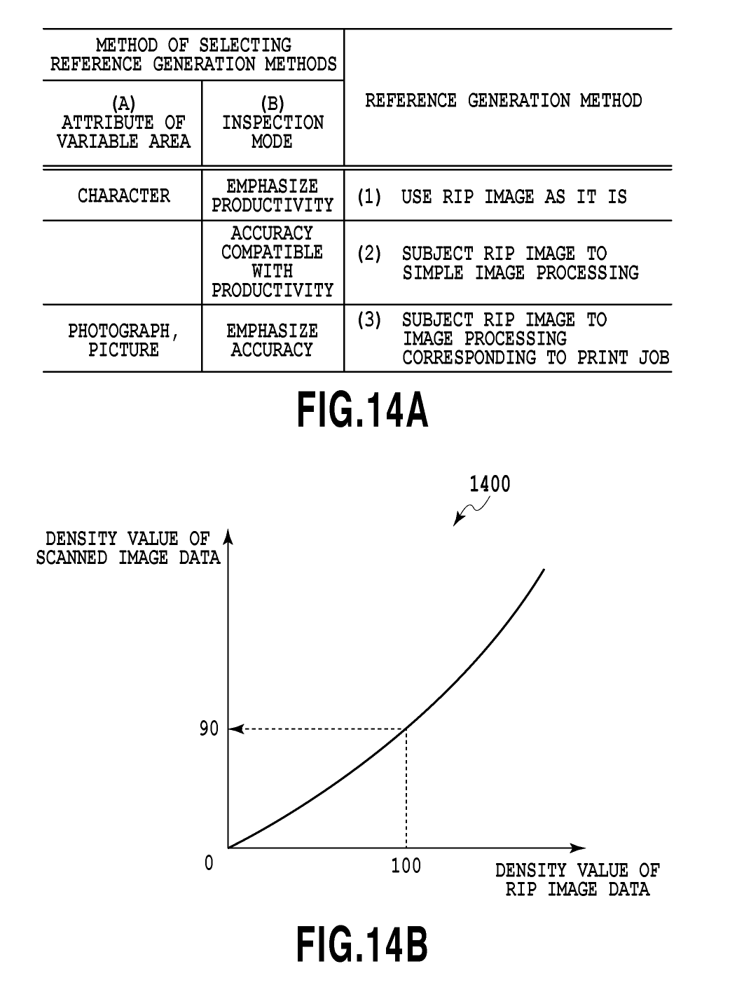

Next, the method of generating reference image data in a variable area, carried out in S1309 in the inspection processing in variable printing in the embodiment will be described using FIGS. 14A and 14B. The reference image data can be generated by, for example, three methods (1) to (3) shown in FIG. 14A.

First, the generation method (1) is a method of using RIP image data as it is as reference image data without performing image processing thereon, that is, a method similar to that in the existing inspection processing. Note that, in the above embodiment, an example of replacing only the variable area has been described, but in the case of emphasizing productivity, such a generation method (1) can be carried out.

The generation method (3) performs print image processing and/or scanned image processing on RIP image data in accordance with a print job. Therefore, this method allows for the processing in which a density difference between the RIP image data and the scanned image data related to a printed material is taken into consideration, for example.

Moreover, the generation method (2) is an approach of performing image processing on RIP image data, to thereby generate reference image data, as with the generation method (3), and is a method of using simpler image processing than the generation method (3).

Next, FIG. 14B shows an example of a density conversion table used in the generation method (2) of reference image data. As shown in FIG. 14B, a relationship of density values between the scanned image data and the RIP image data stored in the reference image data storing unit 503 by the inspection processing is stored into the reference image data storing unit 503 as a density conversion table 1400.

The reference image data generating unit 502 performs density conversion processing using the density conversion table 1400 on the RIP image data, and thus reproduces image processing in simply generating the scanned image data from the RIP image data. For example, in the case where the density value of a certain pixel in the RIP image data is “100”, from the density conversion table 1400, the density value of this pixel of the reference image data can be converted to “90”.

Therefore, there can be generated reference image data having a smaller fluctuation in the density caused by the image processing than the generation method (1) and having a reduced image processing time of the RIP image data in generating the reference image data, in comparison with the generation method (3).

A selection method of the above three reference image data generation methods includes the following two methods (A) and (B) as shown in FIG. 14A. In the selection method (A), the control unit 507 selects the reference image data generation method based on attribute information of a variable area. The attribute information of the variable area is included in the print job. For example, in the case where the attribute of a variable area is a character, the inspection whether or not the character itself rather than the density of the character is properly printed is required. Therefore, for variable data with the attribute of a character, the reference image data generating unit 502 may select the above-described generation method (1).

Moreover, in the case where the attribute of a variable area is a photograph or a picture, the control unit 507 determines that the inspection of the density requires high accuracy, and the reference image data generating unit 502 may generate reference image data using the generation method (3).

In contrast, in the selection method (B), a user selects a reference image data generation method based on an inspection mode setting that is specified at the same time when a print job is set. For example, in the case where a user selects a production emphasizing mode of the inspection processing, through the use of the RIP image data as it is as the reference image data just like in the above-described generation method (1), the need for the image processing for generating the reference image data is eliminated. Therefore, a high productivity of the image inspection system can be maintained.

In contrast, in the case where a user selects an accuracy emphasizing mode of the inspection processing, the reference image data generating unit 502 generates the reference image data by using the generation method (3). In this case, although a certain degree of reduction in the productivity of the image inspection system is caused by the amount of the image processing time of RIP image data, the density can be inspected with a high degree of accuracy. Furthermore, in the case where a user selects a productivity-compatible-with-accuracy mode of the inspection processing, the reference image data generating unit 502 may generate the reference image data by using the generation method (2).

As described above, for the inspection processing in variable printing, through the switching by the control unit 507 or a user of the methods of generating the reference image data of a variable area, there can be realized the inspection processing in accordance with the attribute of an image to be inspected and/or the inspection mode required by a user.

Note that a program for performing the operations related to the image inspection system described in the embodiments may be read by a computer and various kinds of operations may be performed by the computer.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-109443, filed May 11, 2012, which is hereby incorporated by reference herein in its entirety.

What is claimed is:

1. A device comprising:
a scanning unit configured to scan a printed material obtained by printing image data;
a setting unit configured to set reference data based on the image data; and
a determining unit configured to determine whether a printed material is proper by comparing the image data obtained by the scan with the reference data, wherein
the setting unit sets again the reference data based on the image data obtained by the scan for a subsequent printed material in a case where the determining unit determines a printed material to be proper.

2. The device according to claim 1, wherein
the determining unit determines a printed material to be proper in a case where a difference between the image data obtained from the comparison and obtained by the scan and the reference data is within a threshold range.

3. The device according to claim 2, wherein
the determining unit determines a printed material to be proper by using a first threshold range in a case where the reference data prior to setting again is used, and by using a second threshold range in a case where the reference data after setting again is used, and wherein
the second threshold range is narrower than the first threshold range.

4. A method comprising the steps of:
scanning a printed material obtained by printing image data;
setting reference data based on the image data; and
determining whether a printed material is proper by comparing the image data obtained by the scan with the reference data, wherein
the setting step includes setting again the reference data based on the image data obtained by the scan for a subsequent printed material in a case where the determining determines a printed material to be proper.

5. The method according to claim 4, wherein
the determining step includes determining a printed material to be proper in a case where a difference between the image data obtained from the comparison and obtained by the scan and the reference data is within a threshold range.

6. The method according to claim 5, wherein
the determining step includes determining a printed material to be proper by using a first threshold range in a case where the reference data prior to setting again is used, and by using a second threshold range in a case where the reference data after setting again is used, and wherein the second threshold range is narrower than the first threshold range.

7. An image inspection device comprising:
a determination criteria generating unit configured to obtain a density value of an image, and generate determination criteria defining a density range based on the density value;
a scanned image generating unit configured to scan a first and a second printed material on which the image is printed, and generate a first and a second scanned image;
a setting unit configured to obtain a density value of the first scanned image, and set the first scanned image to a reference image in a case where the density value of the first scanned image is within a range defined by the determination criteria; and
a determining unit configured to obtain a density value of the second scanned image, and determine whether or not a density value of the second scanned image is within the range defined by the determination criteria.

8. The image inspection device according to claim 7, further comprising an image processing unit configured to process the image so as to reduce a characteristic difference between the image and the scanned image, wherein
the determination criteria generating unit generates determination criteria based on a density value of the image processed by the image processing unit.

9. The image inspection device according to claim 7, wherein
in a case where the first and second printed materials are made in a plural number for one print job and the second printed material is printed after making the first printed material,
the determination criteria generating unit generates determination criteria used for the second printed material that is different from determination criteria used for the first printed material, the determination criteria having a density range defined based on a density value of the reference image, wherein
the density range that is defined by the determination criteria used for the second printed material is narrower than the density range defined by the determination criteria used for the first printed material, and wherein
the determining unit obtains a density value of the second scanned image corresponding to the second printed material, and determines whether or not the density value of the second scanned image is within the range defined by the determination criteria used for the second printed material.

10. The image inspection device according to claim 7, wherein
in a case where the first and second printed materials are printed materials of different pages among printed materials including a plurality of pages based on a print job, and the first printed material and the second printed material each include a template area where a same image is printed and a variable area where a different image is printed,
the determination criteria generating unit generates determination criteria defining a density range based on a density value of the reference image corresponding to the first printed material, as determination criteria used for the template area of the second printed material, and generates determination criteria defining a density range based on a density value of an image to be printed onto the second printed material, as determination criteria used for the variable area of the second printed material, and wherein
the determining unit obtains a density value of the second scanned image corresponding to the second printed material, and determines whether or not the density value of the second scanned image is within the range defined by the determination criteria used for the second printed material.

11. An image inspection method comprising:
a determination criteria generating step of obtaining a density value of an image, and generating determination criteria defining a density range based on the density value;
a scanned image generating step of scanning a first and a second printed material on which the image is printed, and generating a first and a second scanned image;
a setting step of obtaining a density value of the first scanned image, and setting the first scanned image to a reference image in a case where the density value of the first scanned image is within the range defined by the determination criteria; and
a determining step of obtaining a density value of the second scanned image, and determining whether or not the density value of the second scanned image is within the range defined by the determination criteria.

12. A program for causing a computer to execute the image inspection method according to claim 11.
